(19) United States
(12) Patent Application Publication
(10) Pub. No.: US 2005/0237751 A1
(43) Pub. Date: Oct. 27, 2005

(54) Detachable lampshade for a lamp

(76) Inventor: Chaur-Bing Chen, Tali City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/832,846

(22) Filed: Apr. 27, 2004

(51) Int. Cl. F21V 11/00

(52) U.S. Cl. 362/358; 362/352; 362/360

(57) ABSTRACT

A detachable lampshade for a lamp has at least two resilient sheets, multiple engaging pieces, and multiple fastening devices. Each resilient sheet is U-shaped and has two flanges. Each engaging piece has two channels longitudinally defined inside the engaging piece to respectively receive two flanges of two adjacent resilient sheets inside. Lastly, the multiple fastening devices clamp the engaging piece and the attached flanges of the two adjacent resilient sheets together. Thereby, the detachable lampshade can be conveniently disassembled or reassembled.

### BACKGROUND OF THE INVENTION

1. Field of the Invention

The present invention relates to a detachable lampshade for a lamp, and more particularly to a detachable lampshade to be conveniently reassembled without using tools or to be easily disassembled to minimize the storage space of the lampshade when not in use.

2. Description of Related Art

A lamp such as a table lamp or a stand lamp substantially comprises a stand, a bulb and a lampshade. The lampshade is mounted on the stand and covers the bulb to avoid someone accidentally touching the hot bulb and further to increase the beauty of the appearance of the lamp. The conventional lampshade comprises a frame and a shade. The frame is attached to the stand of the lamp. The shade is mounted on the frame to cover the bulb.

However, because the conventional frame is an integral structure, the frame of the conventional lampshade cannot be disassembled and reassembled easily. Packing and storing the lampshade is inconvenient because the lampshade is large and cannot be temporarily reduced in size. This is especially important in a retail store where space for stock is limited and thus expensive. For example, if a particular lampshade becomes very popular and the limited existing stock sells out quickly, further customers will be disappointed by not being able to make the purchase.

The present invention has arisen to mitigate or obviate the disadvantages of the conventional lampshade mounted on a lamp.

### SUMMARY OF THE INVENTION

The main objective of the present invention is to provide a detachable lampshade that can be disassembled or reassembled conveniently.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a detachable lampshade in accordance with the present invention, wherein the lampshade is mounted on a stand;

FIG. 2 is an enlarged exploded perspective view in part of the detachable lampshade at joints in FIG. 1;

FIG. 3 is an enlarged top plane view in part of the joint of the detachable lampshade of the lampshade combined;

FIG. 4 is an enlarged perspective view showing connection between the stand and the detachable lampshade;

FIG. 5 is an exploded perspective view of joints of another embodiment of the detachable lampshade in accordance with the present invention;

FIG. 6 is an enlarged top plane view of the joints of the detachable lampshade in FIG. 5; and

FIG. 7 is an enlarged perspective view showing connection between the stand and the detachable lampshade in FIG. 5.

### DETAILED DESCRIPTION OF THE PREFERRED EMBODIMENT

A detachable lampshade for a lamp in accordance with the present invention comprises at least two resilient sheets, multiple engaging pieces, and multiple fastening devices. Each engaging piece is detachably attached between the two adjacent resilient sheets by means of the multiple fastening devices. Thereby, the detachable lampshade can be conveniently disassembled or reassembled when the fastening devices are disengaged from the engaging pieces.

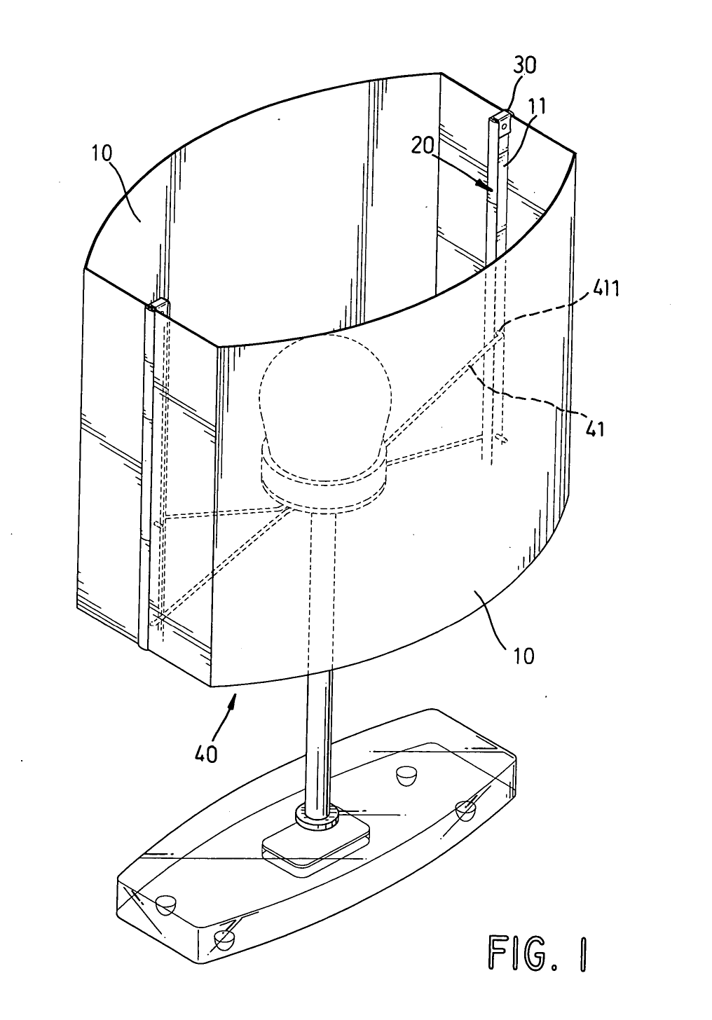

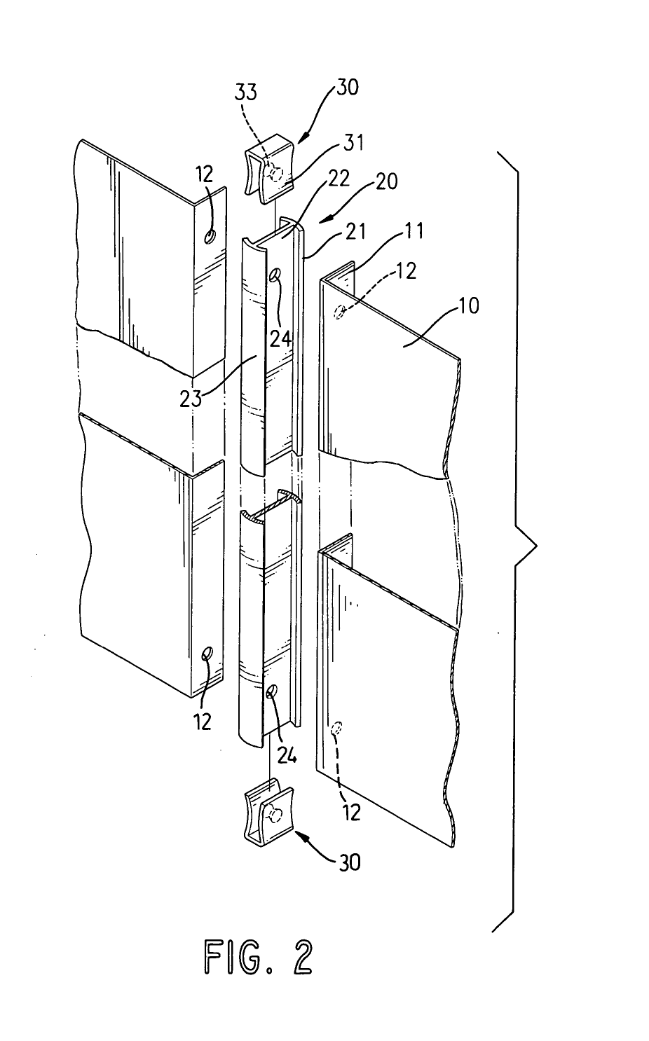

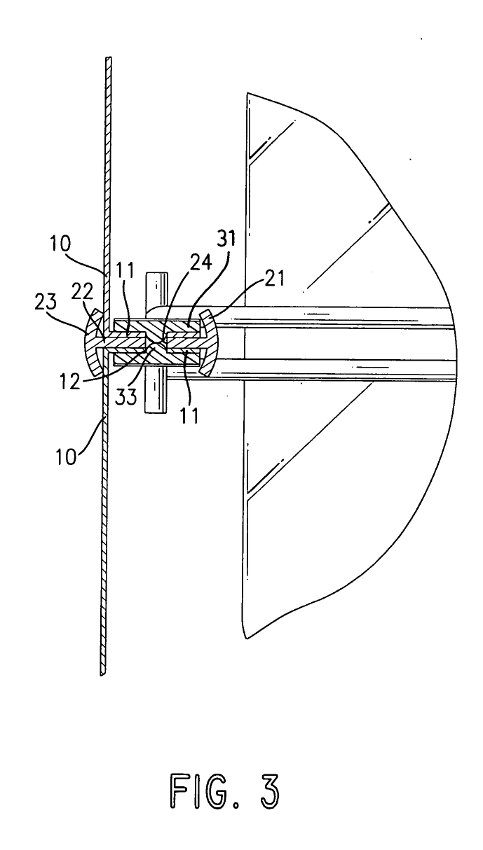

With reference to FIGS. 1, 2 and 3, a preferred embodiment of the detachable lampshade is composed of two resilient sheets (10), two engaging pieces (20), four fastening devices (30), and four optional extending rods (41).

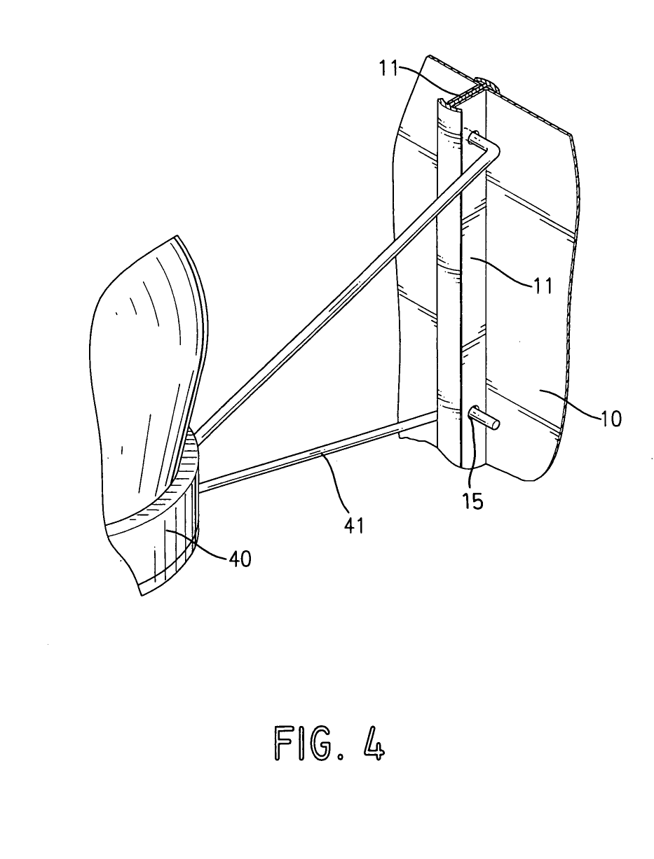

Each resilient sheet (10) is formed into a U-shaped body with a top edge, a bottom edge, and two sides edges, and has two flanges (11) and multiple holes (12, 15). The two flanges (11) are respectively and inwardly formed on the two side edges. Two stub holes (12) are defined in each of the two flanges (11) respectively near the top edge and the bottom edge. Two through holes (15), as shown in FIG. 4, are defined between the two stub holes (12) on each flange (11).

Each engaging piece (20) is a straight rod with an H-shaped cross-section and has a top end, a bottom end, a middle section (22), two side-sections (21, 23), and multiple holes (24). The middle section (22) and the two side sections (21, 23) define two channels at respective sides of the middle section (22) to respectively receive the two flanges (11) of the two adjacent resilient sheets (10). Two stub holes (24) are defined in the middle section (22) respectively at the top end and the bottom end to correspondingly align with the stub holes (12) on the flanges (11). Two through holes (not shown) are defined between the two stub holes (24) in the middle section (22) of the engaging pieces (20) to correspondingly align with the through holes (15) in the flanges (11).

The four fastening devices (30) are individually attached to the top end and the bottom end of the two engaging pieces (20) to fasten the resilient sheets (10) onto the engaging pieces (20). Each fastening device (30) is a U-shaped clasp and has two wings (31). Each wing (31) has an inner face and a stub (33) formed on the inner face to engage with the stub holes (12, 24) in the resilient sheets (10) and the engaging piece (20). Thereby, the resilient sheets (10) are combined together to compose a lampshade surrounding a lamp stand (40) with a bulb base (not numbered).

Particularly referring to FIG. 4, the optional extending rods (41) are mounted between the engaging pieces (20) and the lamp stand (40). Each extending rod (41) has an abutting end (not numbered) and an insertion end (411). The abutting end is firmly attached under the bulb base and the insertion end (411) inserts into the aligned through holes (15) to support the lampshade around the lamp stand (40).

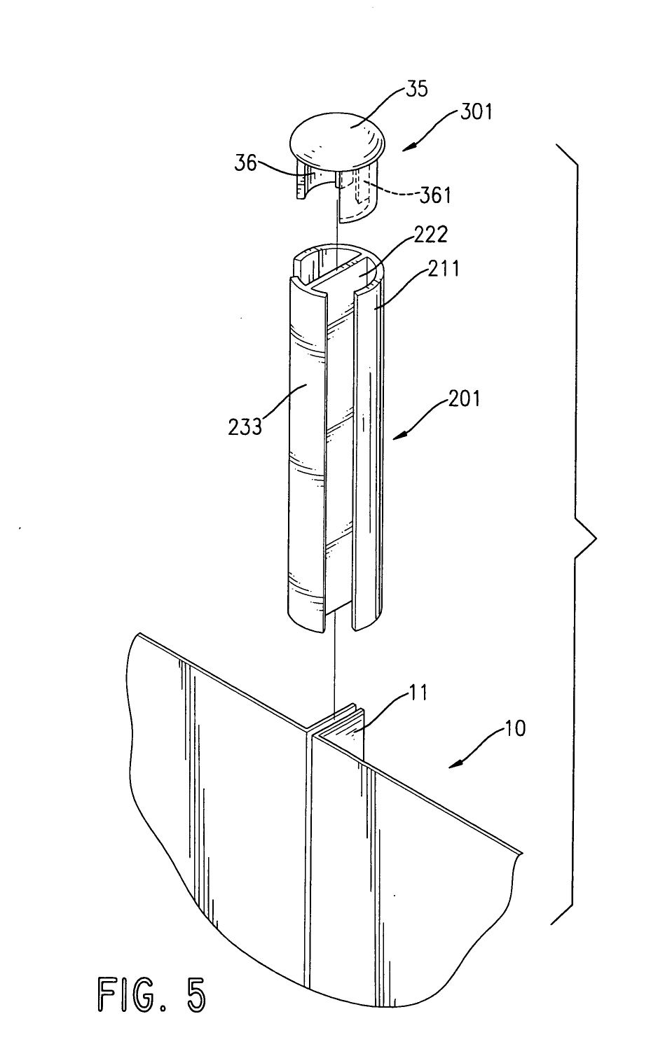

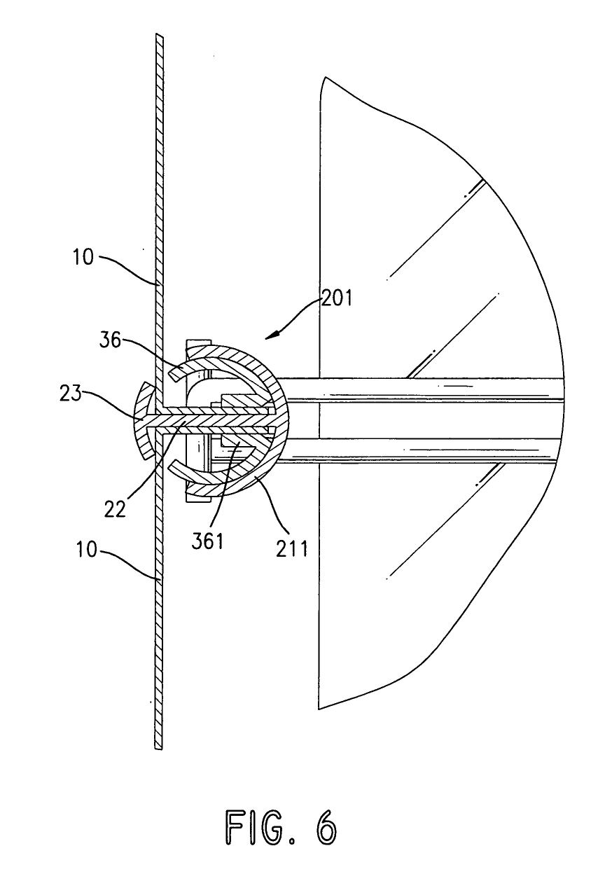

With reference to FIGS. 5 to 7, another embodiment of the detachable lampshade in accordance with the present invention has different configurations of the engaging piece (201) and the fastening device (301).

The engaging piece (201) is substantially an elongated cylinder and has a short side section (233), a curved side section (211) and a middle portion (222) with two ends connected between the short side section (233) and the curved side section (2 11). The curved side section (211) extends to the short side section (233) to perform the cylindrical periphery. Two channels (not numbered) are defined at respective sides of the middle section (222) between the short side section (233) and the curved side section (211) to respectively receive two flanges (11) of two resilient sheets (10).

The fastening device (301 ) is a domed cap (35) with a flat bottom face and has two outer walls (36) and two abutting plates (361). The two outer walls (36) are circularly formed on the flat bottom face of the domed cap (35) and respectively wedged into the channels of the engaging piece (201). The two abutting plates (361) are respectively formed at ends of the two outer walls (36) in parallel with each other so that a gap is constructed between the two abutting plates (361). The middle section (222) of the engaging piece (201) with the attached flanges (11) of the resilient sheets (10) are clamped between the two abutting plates (361). Thereby, the two resilient sheets (10) and the engaging piece (201) are firmly combined together to compose the detachable lampshade.

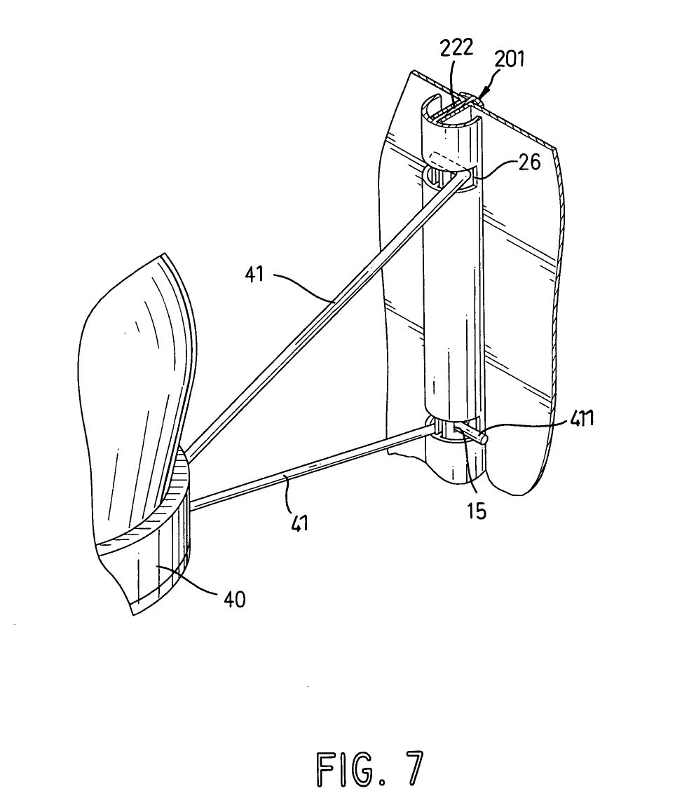

With particularly reference to FIG. 7, the lampshade in FIG. 5 is also combined with the lamp base by means of the extending rods. Therefore, each engaging piece (201) further has two through holes (not numbered) defined on the middle section (222) at intervals to align with the through holes (15) in the flanges (11). Additionally, two transversal slits (26) are defined in the curved side section (211) to reveal the through holes (15) to allow the insertion end (411) of the extending rod (41) to penetrate and engage with the through hole (15).

According to foregoing description, all elements of the detachable lampshade can be assembled or dissembled without any tools. Moreover, the detachable lampshade also does not occupy much space when disassembled because each resilient sheet (10) can be detached from the other one to make the size of the lampshade as small as possible.

Although the invention has been explained in relation to multiple preferred embodiments, many other possible modifications and variations can be made without departing from the spirit and scope of the invention as hereinafter claimed.

1. A detachable lampshade for a lamp comprising:
at least two resilient sheets (10), each resilient sheet (10) having a top edge, a bottom edge, two side edges and two opposite flanges (11) respectively formed at the two side edges;
multiple engaging pieces (20) attached between the at least two resilient sheets (10), each engaging piece (20) mounted between two adjacent resilient sheets (20), being a rod with an H-shaped cross-section and having two side-sections (21, 23), a middle section (22) connected between the two side sections (21, 23) to define two channels at two sides of the middle section (22) to respectively receive two flanges (11) of the two adjacent resilient sheets (10); and
multiple fastening devices (30) clamping the flanges (11) of the two adjacent resilient sheets (10) and the middle section (22) of the engaging pieces (20), each fastening device (30) being a U-shaped clasp.

2. The detachable lampshade as claimed in claim 1, wherein each resilient sheet (10) further has two stub holes (12) respectively defined in each of the two flanges (11) near the top edge and the bottom edge;
each engaging piece (20) further has two stub holes (24) defined in the middle section (22) respectively near the top end and the bottom end of the engaging piece (20) to correspondingly align to the stub holes (12) on the flanges (11) of the adjacent resilient sheets (10) between which the engaging piece (20) is mounted; and
each fastening device (30) has two wings (31) with two inner face and two stubs (33) respectively formed on the inner face of the wings (31) to engage with the stub holes of the flanges (11) of two corresponding resilient sheets (10) and a corresponding one of the engaging pieces (20).

3. The detachable lampshade as claimed in claim 2, wherein each resilient sheet (11) further has two through holes (15) defined in each of the two flanges (11) between the two stub holes (12); and
each engaging piece (20) further has two through holes defined in the middle section (22) of the engaging pieces (20) to correspondingly align with the through holes (15) on the flanges (11) on the two corresponding adjacent resilient sheets (10).

4. A detachable lampshade for a lamp comprising:
at least two resilient sheets (10), each resilient sheet (10) having a top edge, a bottom edge, two side edges and two opposite flanges (11) respectively formed at the two side edges;
multiple engaging pieces (201) attached between the at least two adjacent resilient sheets (10), each engaging piece (201) clamped between two adjacent resilient sheets (10), being substantially an elongated cylinder and having a short side section (233), a curved side section (211) and a middle portion (222) connected between the short side section (233) and the curved side section (211), wherein the curved side section (211) extends to the short side section (233) to perform the cylindrical periphery and to define two channels respectively at two sides of the middle section (222) between the short side section (233) and the curved side section (2 11) to respectively receive two flanges (22) of the two resilient sheets (10); and
multiple fastening devices (30) clamping the flanges of at least two resilient sheets (10) and the middle section (222) of the engaging pieces (201), each fastening device (30) being a domed cap (35) with a flat bottom face and having two outer walls (36) and two abutting plates (361), wherein the two outer walls (36) are circularly formed on the flat bottom face of the domed cap (35) and respectively wedged into the channels of a corresponding one of the engaging pieces (201); wherein, the two abutting plates (361) are respectively formed in parallel orientation under the flat bottom face to clamp the flanges (11) of two corresponding adjacent resilient sheets (10) and the middle portion (222) of the corresponding engaging piece (201).

5. The detachable lampshade as claimed in claim 4, wherein each resilient sheet (10) further has two through holes (15) defined in each flange (11) between the two stub holes (12); and
each engaging piece (201) further has two through holes defined in the middle section (222) of the engaging pieces (201) to correspondingly align to the through holes (15) on the flanges (11) of the two corresponding adjacent resilient sheets (10) and two transversal slits (26) are defined in the curved side section (211) to reveal the aligned through holes (15) on the flanges (11) of the two corresponding adjacent resilient sheets (10) and on the middle section (222) of the engaging piece (201).
